(19) United States
(12) Patent Application Publication
(10) Pub. No.: US 2015/0187151 A1
(43) Pub. Date: Jul. 2, 2015

(54) SYSTEMS AND METHODS FOR CONTROLLING IN-ROOM SAFES WITH NFC-ENABLED DEVICES

(71) Applicant: ASSA ABLOY AB, Stockholm (SE)

(72) Inventors: Stig Lagerstedt, Richardson, TX (US); Daniel Berg, Sundbyberg (SE); Daniel Bailin, Castle Rock, CO (US); Mark Robinton, Lebanon, NH (US); Michael Lawrence Davis, Amherst, NY (US)

(21) Appl. No.: 14/416,364

(22) PCT Filed: Jul. 26, 2013
(86) PCT No.: PCT/IB2013/002144

§ 371 Date: Jan. 22, 2015

Related U.S. Application Data
(60) Provisional application No. 61/676,827, filed on Jul. 27, 2012.

(51) Int. Cl. G07C 9/00

(52) U.S. Cl. CPC G07C 9/00111

(57) ABSTRACT

Methods, systems and devices for employing the Near Field Communications (NFC) protocol are described. Specifically, a safe or similar in-room security device is configured to exchange communications with one or more NFC-enabled devices in accordance with the NFC protocol. Based on the exchange of information with the NFC-enabled devices, the safe is configured to make one or more access control decisions.

### FIELD OF THE DISCLOSURE

The present disclosure relates generally to access control systems, methods and devices for controlling access in multi-room facilities with cascading access levels and more particularly access control mechanisms well suited for use controlling in-room safes with NFC-enabled devices.

### BACKGROUND

Multi-room or multi-suite facilities such as hotels, apartment buildings, office complexes, dormitories, office buildings, classrooms, cruise ships, laboratory facilities and similar structures have many devices that, if monitored and/or controlled in a manner not currently done, will generate new functionalities in the areas of facility security, facility operational efficiency, and facility maintenance (for the facility operator and the facility user) and will generate an overall cost reduction in facility management and maintenance.

A visiting hotel guest may acquire access control cards or similar schemes that are encoded with information such as the guest stay duration, room number and other preferences such as access to common rooms, spa and added services, etc. These cards or similar schemes provide access to some general area through being able to unlock or otherwise deactivate some access control mechanism to that general area. However, separate access control is sometimes needed for devices or subareas within that general area, for example, a safe within a guest room.

Accordingly, there is a need in the art for access control systems, methods and devices that would work in multi-room facilities with cascading access levels.

### SUMMARY

It is, therefore, one aspect of the present disclosure to provide methods, systems, and devices for controlling access in multi-room facilities with cascading access levels. More specifically, embodiments of the present disclosure provide methods, systems and devices which allow a guest or user of a multi-room facility to access in-room safes with NFC-enabled devices.

Additionally, embodiments of the present disclosure provide mechanisms which allow a guest who has an access credential to access a room and to access the in-room safe, while preventing others such as housekeepers who have an access credential to access the room to access the in-room safe. Accordingly, cascading access levels can be used to control access to various devices and/or objects in a room.

In some embodiments, a method is provided that generally comprises:

receiving a Near Field Communications (NFC) signal at a safe from an NFC-enabled communication device;

analyzing, by a processor operatively and mechanically coupled to the safe, the NFC signal; and

determining whether or not to unlock a door of the safe based on the analysis of the NFC signal.

In some embodiments, the NFC signal received at the safe includes information obtained by the NFC-enabled communication device from another door that is within close proximity to the safe. As an example, the NFC-enabled communication device may receive a first set of data from a room door, in-room thermostat, or the like and the first set of data may be provided from the NFC-enabled communication device to the in-room safe. The processor that analyzes the NFC signal received from the NFC-enabled communication device may be configured to condition opening the door of the safe based on whether valid data was received by the NFC-enabled communication device from the room door, in-room thermostat, etc.

### BRIEF DESCRIPTION OF THE DRAWINGS

FIG. 1 is a block diagram depicting an access control system for a multi-room facility in accordance with embodiments of the present disclosure;

FIG. 2 is a block diagram depicting an access control module in accordance with embodiments of the present disclosure;

FIG. 3 is a block diagram depicting an access credential in accordance with embodiments of the present disclosure;

FIG. 4 is a block diagram depicting a safe access module in accordance with embodiments of the present disclosure;

FIG. 5 is a flow diagram depicting an access control method in accordance with embodiments of the present disclosure;

FIG. 6 is a flow diagram depicting a safe access control method in accordance with embodiments of the present disclosure; and

FIG. 7 is a flow diagram depicting a safe status check method in accordance with embodiments of the present disclosure.

### DETAILED DESCRIPTION

The disclosure will be illustrated below in conjunction with an exemplary access control system. Although well suited for use with, (e.g., a system using access control readers and/or credentials) the disclosure is not limited to use with any particular type of access control system or configuration of system elements. Those skilled in the art will recognize that the disclosed techniques may be used in any data messaging application in which it is desirable to increase the efficiency or desirability of an access process, whether such process includes adding, terminating or altering access privileges.

The exemplary systems and methods of this disclosure will also be described in relation to analysis software, modules and associated analysis hardware. However, to avoid unnecessarily obscuring the present disclosure, the following description omits well-known structures, components and devices that may be shown in block diagram form, are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

Although various embodiments of the present disclosure will be described below in connection with updating access data on an access credential and in particular access data used within a multi-room facility, one skilled in the art will appreciate that embodiments of the present disclosure are generally applicable to updating any type of data on a portable identification device or portable memory. Thus, the mechanisms and methods discussed in connection with performing an access data update or encoding process can be applied to updating or encoding any other type of data (e.g., configuration data, security data, keys, etc.) in a similar manner without departing from the scope of the present disclosure.

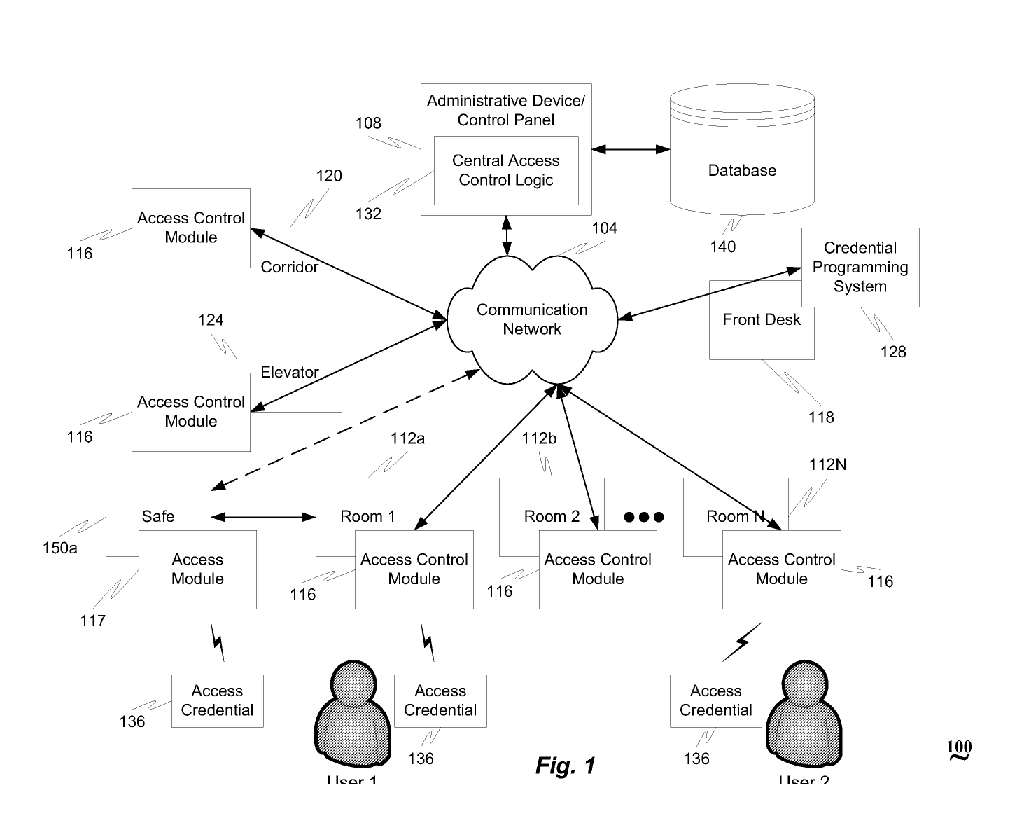

Referring initially to FIG. 1, an exemplary access control system 100 is depicted in accordance with at least some embodiments of the present disclosure. The access control system 100 may include a communication network 104 connecting a plurality of access control modules 116 and a credential programming system 128 to an administrative device 108, which may also be referred to as a control panel.

The administrative device 108 may include access control logic 132 that is generally responsible for administering the access control system 100 of the multi-room facility. In other words, the access control logic 132 of the administrative device 108 may provide a central location for administering the security of the multi-room facility. For example, the access control logic 132 may be connected to a centralized database 140, which includes guest reservation information (e.g., guest preferences, stay duration, customer preferences, guest contact information and any other information that confirms a guest's reservations to one or more rooms 112a-N within or assets of the multi-room facility). The access control logic 132 may serve as a central source of security information for the various other components of the access control system 100.

The access control logic 132 may be adapted to respond to requests generated by the access control modules 116 and credential programming system 128 (e.g., by providing requested information to the requesting device or confirming the accuracy of information provided by the requesting device). Alternatively, or in addition, the access control logic 132 may be adapted to provide instructions to the access control modules 116 and credential programming system 128, thereby allowing these devices to administer some or all of the access control system 100 without requiring such devices to communicate with the access control logic 132 during every transaction.

The credential programming system 128 is typically located at a front desk 118 or some other centralized and secure location of the multi-room facility since the credential programming system 128 is usually provided with the capabilities of writing access data to access credentials during guest check-in. Thus, it is generally preferred by owners and operators of the multi-room facility to maintain a certain level of security over the credential programming system 128, since it has the capability of writing access data to credentials which could potentially allow a holder of the credential to access any asset within the multi-room facility. Without some level of control over the credential programming system 128, there could be an increased risk that guests would write access data to their credentials that exceeds the access permissions which would otherwise be provided to the guest. For this reason, almost all current multi-room facilities require a guest to check-in at the front desk 118, so that the guest can obtain an access credential that has access data properly and accurately written thereto.

The access control modules 116, on the other hand, are usually provided to secure various assets within the multi-room facility. For example, access control modules 116 may be provided at access points to various physical assets (e.g., rooms 112a-n, corridors 120, elevators 124, safes within rooms 150a-n, the multi-room facility itself, etc.). Access control modules 116 may also be provided to secure logical assets such as money accounts, customer accounts at a restaurant within the multi-room facility, or computer accounts. For instance, a restaurant within the multi-room facility may allow guests of the multi-room facility to “pay” for meals by putting the balance due on a tab associated with the room. Upon check-out it is assumed that the guest will settle all accounts and pay the balance due for the room and such meals. Accordingly, some restaurants may provide an access control module 116 to secure such accounts and ensure that guests associate their balance with the appropriate room.

Of course, the access control modules 116 may comprise additional functionality, and such additional functionality will be dependent upon the types of credentials 136 used, the communication network 104, the type and/or physical nature of the facility (multiple buildings—geographically separated), the nature of the business (hotel or business) and other design considerations. In accordance with at least one embodiment of the present disclosure, an instruction set (e.g., firmware, software, configuration data, and/or security data) is resident on the access control module 116 to support and control the functions of the access control module 116.

To facilitate such security policies, the access control modules 116 may be adapted to communicate with access credentials 136 carried by users or guests of the multi-room facility via contactless and/or contact-based communication protocols. Such communications will allow the access control modules 116 to identify the access credential 136 presented thereto, as well as determine access permissions for the holder of the access credential 136.

Examples of the communication protocols employed by an access control module 116 to communicate with an access credential 136 include, without limitation, RF-based communications (e.g., ISO 14443A, IS014443B, ISO 15693, Near Field Communications, Bluetooth, Zigbee, WiFi, and any other type of communication protocol that utilizes an RF field at 125 kHz or 13.56 MHz), magnetic-based communications, light-based communications, wire-based communications including ISO 7816, I²C, SPI, as well as other known or yet to be developed communication protocols.

In some embodiments, the access control modules 116 include RF reading and writing (encoding) capabilities. Such access control modules 116 may be referred to as readers/writers. Access control modules 116 with reading and writing capabilities generally include an RF antenna for exchanging RF messages with access credentials 136 during read operations and a separate RF antenna for transmitting RF messages, which encode access credentials 136 during write operations. However, one skilled in the art will appreciate that an access control module 116 may comprise a single antenna that is used during both read and write operations.

In accordance with at least some embodiments of the present disclosure, the communication network 104 is adapted to carry messages between the components connected thereto. Thus, the administrative device 108 is allowed to send messages to and receive messages from an access control module 116 and/or credential programming system 128 via the communication network 104. The communication network 104 may comprise any type of known communication network including wired and wireless or combinations of communication networks and may span long or small distances. The protocols used by the communication network 104 to facilitate controller 116/access control module 116 communications may include, but is not limited to, the TCP/IP protocol, Simple Network Management Protocol (SNMP), Power of Ethernet (POE), Wiegand Protocol, RS 232, RS 485, Current Loop, Bluetooth, Zigbee, GSM, SMS, WiFi, and combinations thereof.

Further details on embodiments of access control system 100 and multi-room facility is disclosed in U.S. Patent Application Publication No. 2011/0187493 A1 to Elfstrom entitled “Methods and Systems for Permitting Remote Check-in and Coordinating Access Control” and is hereby incorporated by reference.

Access control system 100 further includes safes 150a-n in rooms 112a-n, respectively. Safes 150a-n are coupled to a respective access module 117. Access module 117 is configured to open safes 150a-n and is similarly configured as access control module 116 as described above, but with specific functions for safes 150a-n. Access credential 136 is used to verify and open safes 150a-n via access module 117. Embodiments of safes 150a-n and access module 117 will be further described below.

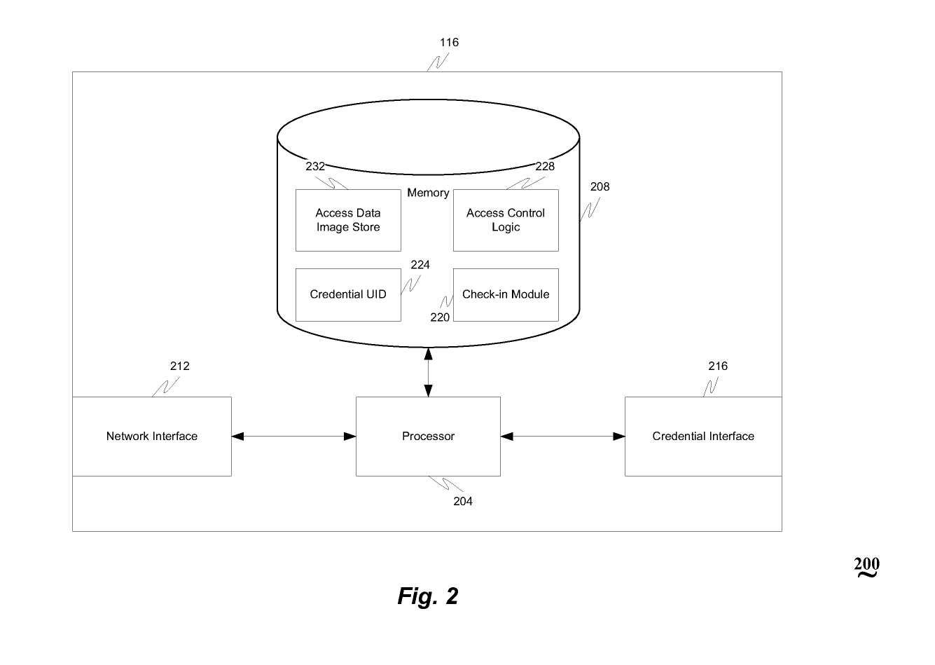

With reference now to FIG. 2, details of an illustrative access control module 116 will be described in accordance with at least some embodiments of the present disclosure. The access control module 116 generally comprises the capability to automatically read data, typically in the form of a message object and/or validation information, from a credential 136. The access control module 116 may also be capable of writing data, typically in the form of a message object, back to the credential 136. This process is also known as encoding the credential 136. In some embodiments, the access control module 116 may be configured to first read a card identifier from a credential 136 and then encode the credential 136 with access data during the same transaction.

The access control module 116, in accordance with at least one embodiment, comprises a credential communication interface 216 used to communicate back and forth with the credential 136. The credential communication interface 216 may comprise an RF communication interface (e.g., an RF antenna), a magnetic communication interface (e.g., a magnetic stripe reader), an optical communication interface (e.g., an infrared detector and transmitter), an electrical contact communication interface, or any other means of communicating information to/from a credential 136.

Connected to the communication interface 216 is a controller or processor 204. In one embodiment, the processor 204 includes a microprocessor, a random number generator and a cryptographic coprocessor. The processor 204 is capable of properly modulating/demodulating data sent to and received from external devices such as the credential 136. The processor 204 controls and determines how the access control module 116 behaves when a credential 136 is presented to it. The processor 204 may include any general-purpose programmable processor, digital signal processor (DSP) or controller for executing application programming. Alternatively, the processor 204 may comprise a specially configured Application Specific Integrated Circuit (ASIC).

The processor 204 may also be provided with control circuitry capable of manipulating an access control device. The access control device is designed to secure a point of access being protected by the access control module 116. The processor 204 is enabled to communicate with the access control device via a network interface 212 or via some other dedicated access control interface. Examples of a typical access control device include, without limitation, an electronic lock, a magnetic lock, or an electric strike for a door, a lock for a computer system, a lock for a database, a lock on a financial account, or a lock on a computer application. In one embodiment, the processor 204 actuates the access control device by sending a signal to the access control device via the network interface 212 based on results of an access decision made by the processor 204. Optionally, the access control device may be integral to the access control module 116 in one embodiment, in which case an access control device interface would not be necessary. In an alternative embodiment, an access control device is external to the access control module 116, thus necessitating some sort of interface between the access control module 116 and access control device. Examples of an access control device interface include any type of data port such as a USB port, serial data port, parallel data port, a convention wire, a wireless communication port such as a Bluetooth data interface, an Ethernet port, or any other type of wired or wireless communication interface.

The network interface 212 is also used to connect the access control module 116 to the communication network 104. Accordingly, communication packets or messages sent by the access control module 116 are received initially by the access control module 116 at the network interface 212. These messages may be forwarded to the processor 204 for further analysis and processing (e.g., decoding, re-formatting and/or data extraction). The network interface 212 provides communication capabilities between the access control module 116 and external servers or other network nodes. Such a communication interface may include a USB port, a wired modem, a wireless modem, a network adapter such as an Ethernet card and Ethernet port, a serial data port, a parallel data port, or any other communication adapter or port known in the art. Of course, the network interface 212 may actually be embodied as multiple network interfaces, for facilitating communications with multiple network types, possibly via different communication protocols.

The access control module 116 may further comprise a memory 208. The memory 208 may be used to store firmware or software instructions that support functionality of the access control module 116. More specifically, the memory 208 may comprise one or more modules that provide the access control module 116 with the ability to make a determination to either permit or deny user access to an asset controlled by the access control module, as well as execute check-in functions normally reserved for the credential programming system.

In some embodiments the memory 208 includes a check-in module 220 and access control logic 228. The access control logic 228 provides the access control module 116 with the ability to read access data from credentials 136 and make a determination as to whether or not the holder of the credential 136 is allowed to access any assets controlled by the access control module 116. Thus, the access control logic 228 may facilitate access data reading operations, access data verification operations, and operations associated with permitting user access to an asset (e.g., unlocking a door, providing access to an account, etc.).

In some embodiments, the check-in module 220 is provided to perform check-in procedures that has traditionally been reserved to the credential programming system 128. In particular, the check-in module 220 may be configured to receive a credential identifier from an access credential 136, compare the credential identifier to a list of credential identifiers, determine that the credential identifier matches at least one credential identifier in the list of credential identifiers, and, based on determining that the credential identifier matches at least one credential identifier in the list of identifiers, invoke the access control module to encode the access credential with access data that is useable by the access credential with other access control modules within the multi-room facility.

As can be appreciated by those skilled in the art, functions and features of the access control logic 228 can be incorporated in the check-in module 220 and vice-versa. There is no requirement that two separate and distinct modules be provided for the access control functions and the check-in functions. Rather, a single module may be configured to provide all of the functionality described herein. Also, it is possible that various features of the access control logic 228 and check-in module 220 may be performed by other modules of memory 208, without departing from the scope of the present disclosure.

It should be appreciated that to complete a read/verify/encode operation, such as the one described above in connection with the check-in module 220, it is important to limit the amount of time that a credential 136 has to be presented to the access control module 116. For example, a typical user will generally not tolerate presenting a credential to an access control module 116 for more than five seconds, or so. Accordingly, the access control module 116 is enabled to read an identification number from the credential 136, confirm that the identification number from the credential 136 matches an identification number associated with a guest that has confirmed reservations and is allowed to check-in at a location other than the front desk 118, and encode the credential 136 with the appropriate access data in a minimal amount of time.

The access data image store 232 may contain one or more access data images that are capable of being written to a credential 136. In some embodiments, the access data contained within the access data image store 232 is formatted specifically for the multi-room facility (i.e., in a format recognized and used by other access control modules 116 within the access control system 100) and may not necessarily be formatted for use by other facilities, even if such facilities have similar access control modules 116. This allows facility system codes and protocols to be used in a distributed fashion without having to use facility keys and while allowing the use of a guest's credential (i.e., a credential not owned by the facility).

In accordance with at least some embodiments of the present disclosure, the access data may include one or more of a site-code identifying the multi-room facility, an encryption key used substantially exclusively by the multi-room facility, a communication protocol used by access control modules within the multi-room facility, a guest identifier substantially uniquely identifying a user of the access credential within the multi-room facility, guest stay duration, room number, identifiers of added services, and a set of access permissions defining whether a user of the access credential is permitted or denied access to particular assets of the multi-room facility. Some or all of the data from the access data image store 232 may be written to a credential 136, depending upon the user of the credential 136 and the reservations associated with the user of the credential 136.

In some embodiments of the disclosure, access control module 116 may write further access data to credential 136. While the majority of access data writes are done in the check-in process and data reads and verifications are done at subsequent access control modules 116, an access control module 116 at a hotel room door for example, may write further access data to credential 136 to provide for further access to controls in the room (i.e. a safe access module). The further written access data may be of the same format as the access data as described above, or may be of another format that is only used to verify the access data with the room door access control and the in-room access controls. In one aspect of the embodiment, access control module 116 of the door may encode access data using a public-private key exclusively paired with the safe access control in the room when access control module 116 verifies that the given credential 136 is allowed to open the safe, such as when the guest's credential is used as opposed to a housekeeping's credential is used. Alternatively, access control module 116 may directly or wirelessly communicate with the in-room access controls to allow or disallow those accesses. In other embodiments, other forms of communication and/or verification can be used as known in the art.

The memory 208 may comprise volatile and/or non-volatile memory. Examples of non-volatile memory include Read Only Memory (ROM), Erasable Programmable ROM (EPROM), Electronically Erasable PROM (EEPROM), Flash memory, and the like. Examples of volatile memory include Random Access Memory (RAM), Dynamic RAM (DRAM), Static RAM (SRAM), or buffer memory. In one embodiment, the memory 208 and the processor 204 are designed to utilize known security features to prevent unauthorized access to the contents of the memory 208 such as side channel analysis and the like.

A power source (not depicted) may also be included in the access control module 116 to provide power to the various devices contained within the access control module 116. The power source may comprise internal batteries and/or an AC-DC converter such as a switch mode power supply or voltage regulator connected to an external AC power source.

Further details on embodiments of access control module 116 are disclosed in U.S. Patent Application Publication No. US2011/0187493 A1 to Elfstrom (“Elfstrom”).

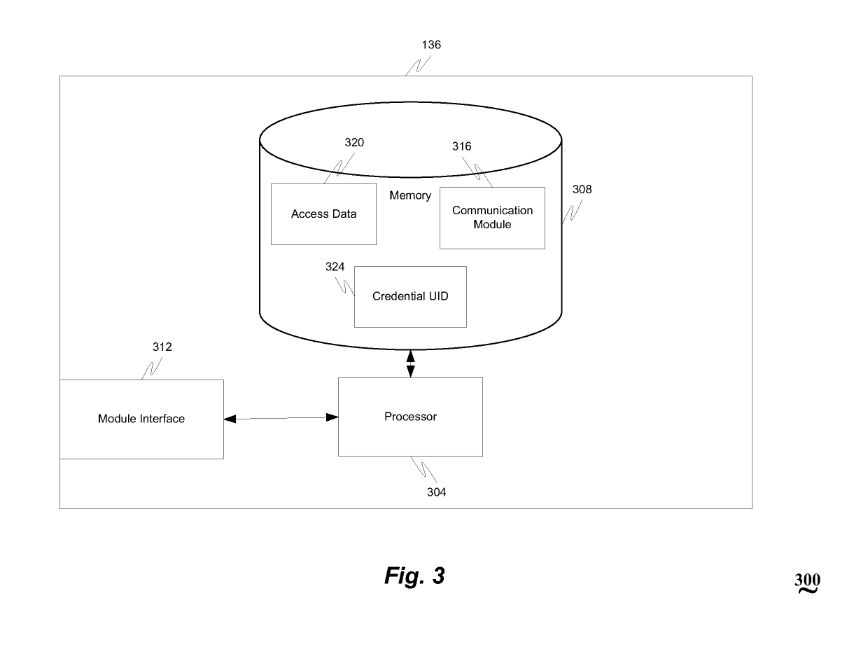

With reference now to FIG. 3, an illustrative access credential 136 will be described in accordance with at least some embodiments of the present disclosure. In some embodiments, the credential 136 is provided with a processor 304, memory 308, and module interface 312. The processor 304 may include a microprocessor, a programmable controller or any other type of processing unit capable of executing the instructions stored in memory 308. Alternatively, or in addition, the processor 304 may be embodied as an Application Specific Integrated Circuit (ASIC).

The processor 304 employs bi-directional interfaces to communicate with the memory 308 and module interface 312. In particular, the processor 304 facilitates data exchanges between the credential 136 and an access control module 116. Such communications are handled at the physical level by the module interface 312. Similar to the credential interface 216, the module interface 312 may comprise an RF communication interface (e.g., an RF antenna), a magnetic communication interface (e.g., a magnetic stripe reader), an optical communication interface (e.g., an infrared detector and transmitter), an electrical contact communication interface, or any other means of communicating information to/from an access control module 116. As can be appreciated by one skilled in the art, the interface 312 may include a Modulation/Demodulation Unit instead of relying upon the processor 304 to perform encoding/decoding operations, message formatting functions, and the like.

The credential 136 may be fabricated as a system-on-chip (SoC) device, a system-in-package (SiP) device, or a system-in-module (SiM) device. In the SoC device, various functional components are integrated onto a single die. Accordingly, in SiP and SiM devices, several SoC devices are combined in a single package (SiP device) or an assembly including SoC and/or SiP devices (SiM device), respectively.

A “passive” credential 136 uses RF signals (i.e., RF radiation) emitted by the access control module 116 as a source of energy for powering the credential 136 and its components (primarily the processor 304). When a passive credential 136 comes within range of an interrogating access control module 116, the access control module 116 provides power to the credential 136 via a querying RF signal. The passive credential 136 converts a portion of RF power collected by the module interface 312 (e.g., an antenna within the interface 312) into DC power facilitating operability of the credential 136. Such a credential 136 can operate only in the active zone of an interrogating access control module 116 and is inactive otherwise.

Alternatively, the credential 136 may comprise an internal (i.e., on-board) power source, e.g., one or several batteries and/or solar cells (“active” credential). In yet another embodiment, the credential 136 comprises both an RF rectifier and internal power source (“semi-active” RFID). Active and semi-active RFIDs can typically be used at greater distances from the access control modules 116 than the passive ones, as well may be provided with additional computing and/or sensing capabilities.

In operation, the access control module 116 and credential 136 use pre-programmed communication protocols. To increase probability of error-free reception, the same messages may redundantly be repeated a pre-determined number of times or during a pre-determined time interval. The protocols and nuances thereof may be defined within the access data 320 that is encoded on the credential 136. In some embodiments, portions of this access data 320 are programmed into the credential 136 prior to a guest checking-in at the multi-room facility and other portions of the access data 320 are encoded onto the credential 136 during the check-in process. For example, the communication protocol information may be pre-programmed data whereas room number, stay duration and other data used to determine access privileges is only programmed during the check-in process. This restriction and separation of access data programming allows the multi-room facility to maintain a certain level of control over the access control system 100.

The communication module 316 may facilitate communications between the credential 136 and access control module 116. In some embodiments, the communication module 316 refers to the access data 320 to ensure that the appropriate communication protocol is used by the credential 136 in communicating with the access control module 116. In some embodiments, if the credential 136 has only been programmed with the minimal amount of access data 320, or has no access data 320 at all (e.g., the user of the credential 136 has not checked-in with the multi-room facility), the communication module 316 is capable of providing a credential UID 324 to an access control module 116 when the credential 136 is interrogated by an access control module 116. The credential UID 324 may comprise any type of identification number, name, symbol, etc. that uniquely or quasi-uniquely identifies the credential 136, or a holder of the credential 136 to the access control module 116. This credential UID 324 may be programmed into the credential 136 upon provisioning and may be secured in a read-only portion of memory 308 to ensure that it is not altered or tampered.

Further, credential 136 may optionally support a write by successively access control module 116 besides the initial check-in process. In an exemplary embodiment, access data 320 may be written to include new access information or further access data by an access control module 116 at a hotel room door when credential 136 is presented to that access control module 116. If access is allowed, access data 320 may be written to include further access information for other access controls in the room, i.e. safe access module.

Accordingly, the memory 308 may be similar to the memory 208 of the access control module 116, in that the memory 308 may include one or more of ROM, EPROM, EEPROM, Flash memory, and the like.

As can be appreciated by those skilled in the art, the access credential 136 may be provided in any type of form factor without departing from the scope of the present disclosure. In some embodiments, the access credential may comprise an RFID card or device having similar functionality like a mobile phone, smart phone, tablet, PDA, ebook reader, portable music player, or the like. In other embodiments, the access credential 136 may comprise a mag-stripe card. In still other embodiments, the access credential 136 may comprise a keyfob. Other form factors known to those skilled in the art will also become readily apparent after reviewing the current disclosure.

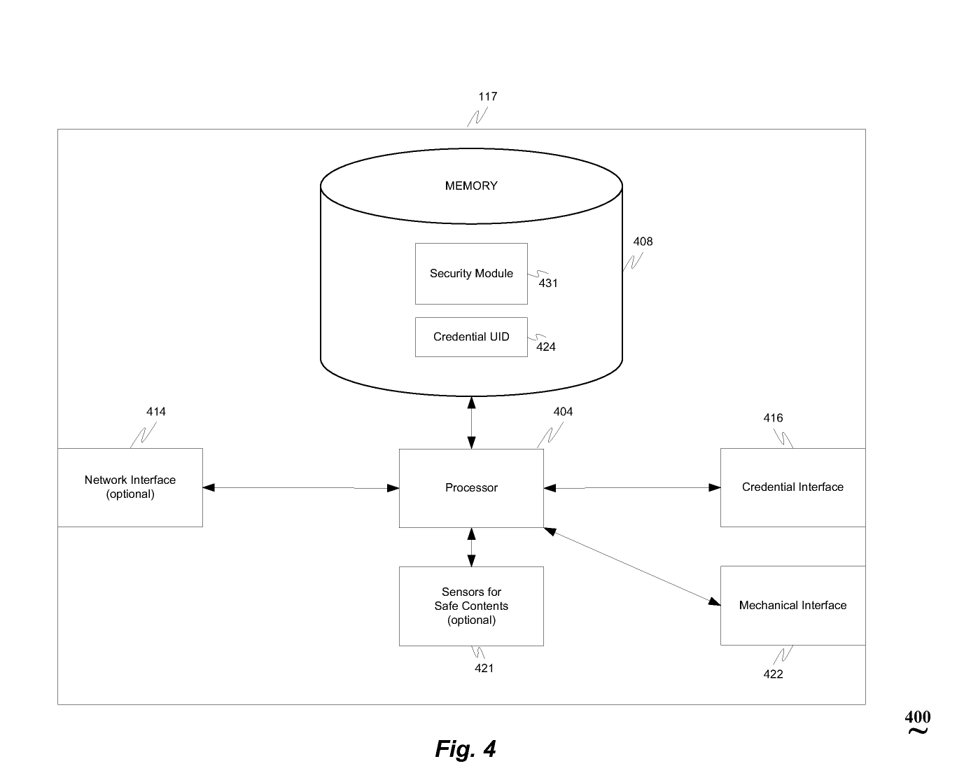

With reference now to FIG. 4, details of an illustrative safe access module 116 will be described in accordance with at least some embodiments of the present disclosure. Safe access module 117 generally comprises the capability to automatically read data, typically in the form of a message object and/or validation information, from a credential 136. The safe access module 117 may also be capable of writing data, typically in the form of a message object, back to the credential 136. This process is also known as encoding the credential 136. In some embodiments, safe access module 116 may be configured to first read a card identifier from a credential 136 and then encode the credential 136 with access data during the same transaction. In other embodiments, safe access module 136 does not necessarily need to write to credential 136.

The safe access module 117, in accordance with at least one embodiment, comprises a credential communication interface 416 used to communicate back and forth with the credential 136. The credential communication interface 416 may comprise an RF communication interface (e.g., an RF antenna), a magnetic communication interface (e.g., a magnetic stripe reader), an optical communication interface (e.g., an infrared detector and transmitter), an electrical contact communication interface, or any other means of communicating information to/from a credential 136.

Connected to the communication interface 416 is a controller or processor 404. In one embodiment, the processor 404 includes a microprocessor, a random number generator, and a cryptographic coprocessor. The processor 404 is capable of properly modulating/demodulating data sent to and received from external devices such as the credential 136. The processor 404 controls and determines how the safe access module 117 behaves when a credential 136 is presented to it. The processor r04 may include any general-purpose programmable processor, digital signal processor (DSP) or controller for executing application programming. Alternatively, the processor r04 may comprise a specially configured Application Specific Integrated Circuit (ASIC).

Optionally, processor 404 may also be provided with control circuitry capable of manipulating an access control device. The access control device is designed to secure a point of access being protected by the safe access module 117. The processor 404 is enabled to communicate with the access control device via an optional network interface 414 or via some other dedicated access control interface, such as mechanical interface 422. Examples of a typical access control device include, without limitation, an electronic lock, a magnetic lock or an electric strike for a door, a lock for a computer system, a lock for a database, a lock on a financial account or a lock on a computer application. In one embodiment, the processor 404 actuates the access control device by sending a signal to the access control device via the network interface 414 based on results of an access decision made by the processor 404. However, access control device may be integral to safe access module 117 in one embodiment, such as mechanical interface 422, in which case an access control device interface would not be necessary. In an alternative embodiment, an access control device is external to safe access module 117, thus necessitating some sort of interface between safe access module 117 and access control device. Examples of an access control device interface include any type of data port such as a USB port, serial data port, parallel data port, a convention wire, a wireless communication port such as a Bluetooth data interface, an Ethernet port, or any other type of wired or wireless communication interface.

The optional network interface 414 is also used to connect safe access module 117 to the communication network 104. Accordingly, communication packets or messages sent by safe access module 117 are received initially by safe access module 117 at the network interface 414. These messages may be forwarded to the processor 404 for further analysis and processing (e.g., decoding, re-formatting, and/or data extraction). The network interface 414 provides communication capabilities between safe access module 117 and external servers or other network nodes. Such a communication interface may include a USB port, a wired modem, a wireless modem, a network adapter such as an Ethernet card and Ethernet port, a serial data port, a parallel data port, or any other communication adapter or port known in the art. Of course, the network interface 414 may actually be embodied as multiple network interfaces, for facilitating communications with multiple network types, possibly via different communication protocols.

Safe access module 117 may further comprise a memory 408. The memory 408 may be used to store firmware or software instructions that support functionality of the safe access module 117. More specifically, the memory 408 may comprise one or more modules that provide safe access module 117 with the ability to make a determination to either permit or deny user access to an asset controlled by the access control module as well as execute check-in functions normally reserved for the credential programming system.

Memory 408 may include a security module 431.

In some embodiments, security module 431 provides security authentication of access credential 136. As network interface 414 may not be present in safe access module 117, safe access module 117, unlike access control module 116 for example, may not be able to access a list of credential identifiers through the network and the central database to compare with the received credential from credential interface 416. Further, safe access module 117 may not want to compare directly the received credential with the list of credential identifiers even if safe access module 117 has network interface 414 and is able to access the network as there may be a need for a stricter security protocol for opening the safe and avoid a man-in-the-middle attack between network interface 414 and the network and the central database. In this case, security module 431 acts to verify that some other access module, i.e. access control module 116 at the room's door, has verified that safe access module 117 grant access to the safe to the given access credential 136. In one aspect of the embodiment, this may be done with an exclusive public-private key pair between access control module 116 and safe access module 117. In other aspects of the embodiment, access control module 116 and safe access module 117 may communication directly or wirelessly, (i.e. through the Zigbee network as disclosed in U.S. Pat. No. 8,102,799 to Alexander et al. entitled “Centralized Wireless Network for Multi-Room Large Properties,”) to verify that credential 136 may open the safe. Safe access module 117 uses mechanical interface 422 to operate the mechanical mechanisms, i.e. unlocking the hinges securing the safe door, to physically open the safe.

The memory 408 may comprise volatile and/or non-volatile memory. Examples of non-volatile memory include Read Only Memory (ROM), Erasable Programmable ROM (EPROM), Electronically Erasable PROM (EEPROM), Flash memory, and the like. Examples of volatile memory include Random Access Memory (RAM), Dynamic RAM (DRAM), Static RAM (SRAM), or buffer memory. In one embodiment, the memory 408 and the processor 404 are designed to utilize known security features to prevent unauthorized access to the contents of the memory 408 such as side channel analysis and the like.

A power source (not depicted) may also be included in the safe access module 117 to provide power to the various devices contained within the safe access module 117. The power source may comprise internal batteries and/or an AC-DC converter such as a switch mode power supply or voltage regulator connected to an external AC power source.

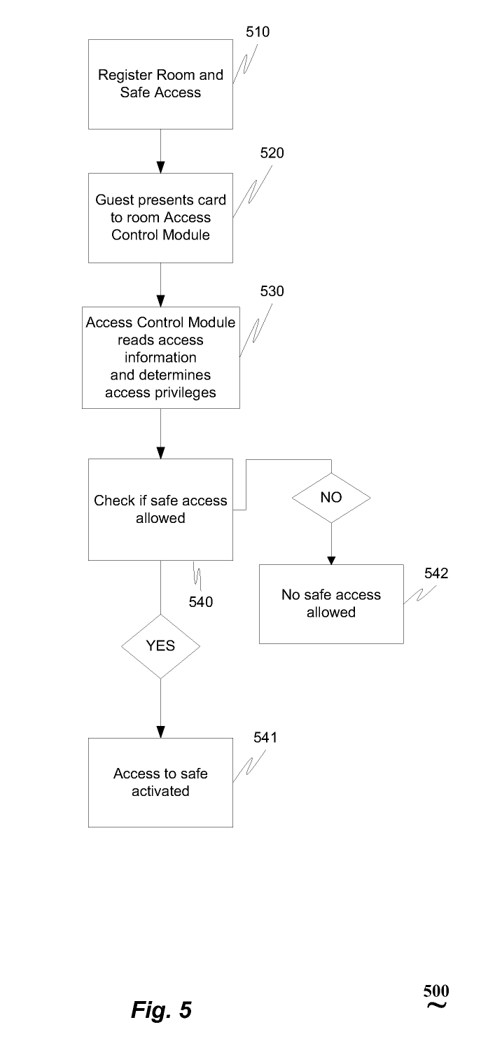

Referring now to FIG. 5, an illustrative method of access control with cascading access levels 500 is disclosed in accordance with some embodiments of the disclosure. Here, room refers to a guest room in a multi-room facility but may also generally reference other areas that are access controlled. Similarly, safe refers to a locked storage area but may also generally reference other access controlled storages or devices that require a separate level of access within the general room.

First, the method 500 registers room and safe access information 510 to an access credential. In some embodiments, room and safe access information is stored to an access credential during the check-in process where the system checks that the guest has confirmed a reservation to a particular room in a multi-room facility. Access information to that particular room and normally to the safe inside that room and other areas of the facility that the guest is deemed to have access to is stored to the access credential. In other embodiments, access information may be electronically sent to the access credential (i.e. via email, or by other methods as known in the art).

Next, the guest presents the access credential to a room's access control module 520. In some embodiments, the presentation of the credential to the access control module causes the credential to transmit one or more messages to the access control module which includes its credential identification number and any other pertinent identification information (i.e. the access information registered in step 510).

Next, the access control module reads the credential access information and determines access privileges 530. The access control module is capable of making access permission decisions based on the credential access information. In some embodiments, the credential access information will provide necessary access information that the access control module can check against its pre-loaded list or through an inquiry to a database in the network. Alternatively, access information includes verification information as known in the art such that the access credential can self-authenticate to that particular access control module, that it is the access credential that belongs to the guest and has been given specific permission for access by the system through a proper check-in or like process. Failure of the credential to provide valid access information will result in the access control module maintaining its asset under secure conditions.

Next, the access control module checks if access to the safe within the room is allowed 540. In some embodiments, the access control module will be able to determine safe access privileges from reading the credential access information in step 530. If access to safe is not allowed, then access control module will allow access to the room but will not complete additional procedures to activate access to safe 542.

If access to safe is determined to be allowed in step 540, access to safe is activated 541. In some embodiments, the access credential may be written to added access information that safe access is activated by the room access control module. The room access control module may also directly or wirelessly send instructions to the safe access module to inform the safe access module to allow access to the credential. In an aspect of an embodiment, access to the safe may be further limited by time or other security protocol, e.g. automatically deactivated when a credential without safe access is presented to the room access control module, to further ensure that access is only activated when the guest is in the room but not to others.

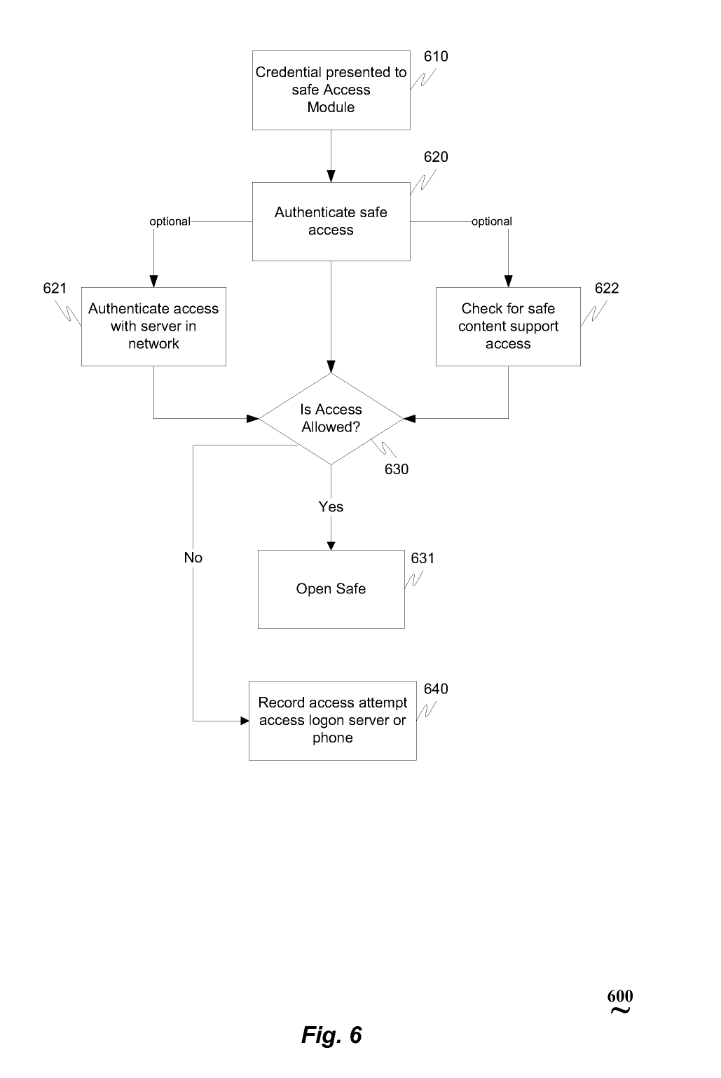

Referring now to FIG. 6, an exemplary method of safe access control 600 is disclosed in accordance with some embodiments of the disclosure.

First, an access credential is presented to the safe access module 610. In some embodiments, safe access information is stored to an access credential during the check-in process where the system checks that the guest has confirmed a reservation to the particular room in a multi-room facility and with safe access permission inside the room. Further safe access activation information may be stored by the particular room's access control module when the access credential is presented in order to enter the room, such that the safe can only be activated when the credential is first presented to enter the room. In other embodiments, the room access control module may directly or wirelessly send access information to the safe when the credential is presented to the room access control module.

Next, the safe authenticates safe access based on the presented credential 620. In some embodiments, the safe access module may check both that the credential is allowed safe access and that the room access control module has activated safe access. Optionally, safe access may be authenticated through the database in the network 621. Still optionally, contents in the safe may be checked to see if it supports access 622. For example, the system may grant someone other than the guest (i.e. a housekeeper, safe access only if the safe is empty).

If safe access is allowed 630, the safe is opened 631. Successful safe access attempt is recorded 640. If safe access is not allowed 630, the safe is not opened and unsuccessful safe access attempt is recorded 640. In some embodiments, access attempts may be logged on the server and may be accessed and viewed through an external device (i.e. a computer or phone). In some aspects of the embodiment, unsuccessful safe access attempts may trigger automatically alert to the appropriate persons or may be analyzed by an algorithm to see if the appropriate persons should be alerted.

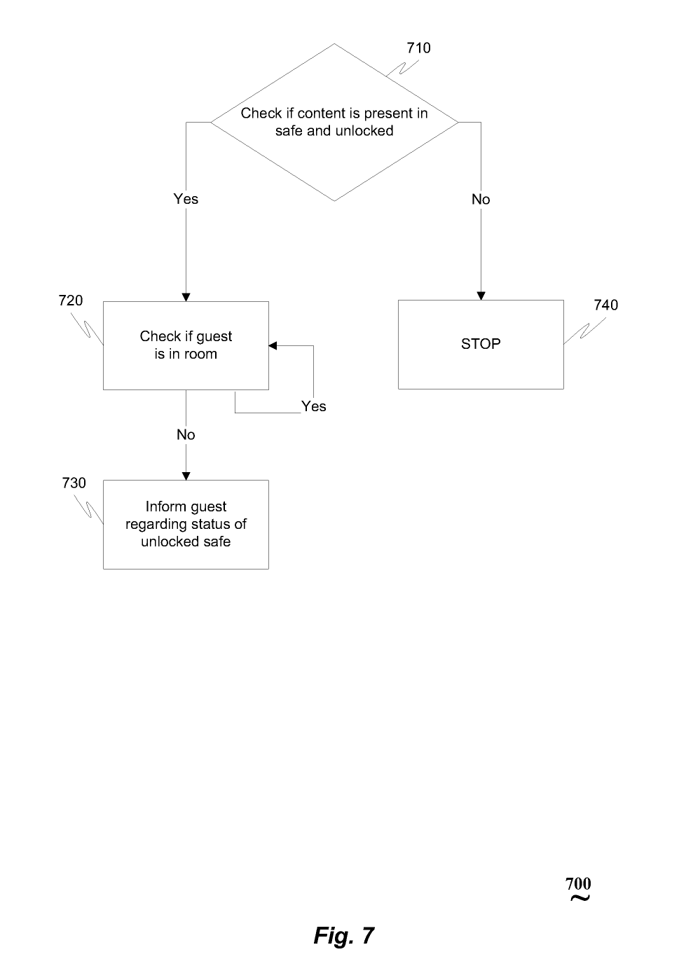

Referring now to FIG. 7, an exemplary method of safe content status check 700 is disclosed in accordance with some embodiments of the disclosure. In some instances, it may be desirable to ensure that the safe is locked and secured when the guest has left the room to provide additional security due to human errors.

First, the method 700 checks if there are any contents present in the safe and if the safe is unlocked 710. Check 710 for contents in the safe can be performed via sensors as known in the art. If there is no content in the safe or the safe is locked, the method stops 740.

Next, the method 700 checks if the guest is in the room 720. Check 720 may be done via various sensors in the rooms as known in the art. In some embodiments, the access credential used by the guest may connect wirelessly to the facility's system, i.e.

Zigbee; the detected presence of the credential may indicate that the guest is still in the room as the credential is needed for accessing various parts of the facility. If the guest is still in the room, check 720 may be performed continuously or at some time interval until no content is present in the safe, the safe is locked, or the guest has left the room.

If the guest has left the room, the guest is informed of the status to the unlocked safe with contents 730. Guest may be informed by a preferred method and/or device chosen previously (i.e. at check-in). For example, the guest's phone, which may also act as an access credential, may be connected to a wireless network (i.e. 4G), and is able receive information about the status of the safe. In some embodiments, guest will be also to issue limited commands via this wireless device to the safe, such as to close and lock the safe remotely.

While the above-described flowcharts have been discussed in relation to a particular sequence of events, it should be appreciated that changes to this sequence can occur without materially effecting the operation of the disclosure. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The present disclosure, in various embodiments, includes components, methods, processes, systems and/or apparatus substantially as depicted and described herein, including various embodiments, subcombinations, and subsets thereof. Those skilled in the art will understand how to make and use the present disclosure after understanding the present disclosure. The present disclosure, in various embodiments, includes providing devices and processes in the absence of items not depicted and/or described herein or in various embodiments hereof, including in the absence of such items as may have been used in previous devices or processes (e.g., for improving performance, achieving ease and\or reducing cost of implementation).

Additionally, the systems, methods and protocols of this disclosure can be implemented on a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a phone, any comparable means, or the like. In general, any device capable of implementing a state machine that is in turn capable of implementing the methodology illustrated herein can be used to implement the various communication methods, protocols and techniques according to this disclosure.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover though the description of the disclosure has included description of one or more embodiments and certain variations and modifications, other variations and modifications are within the scope of the disclosure (e.g., as may be within the skill and knowledge of those in the art, after understanding the present disclosure). It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An in-room safe, comprising:
an access control module configured to exchange communications with a mobile communication device via the Near Field Communications (NFC) protocol.

2. The safe of claim 1, further comprising an interface to communicate with a second access control device of the room in which the safe is located.

3. The safe of claim 2, wherein the interface comprises a wireless interface.

4. The safe of claim 3, wherein the safe exchanges one or more messages with the second access control device to assist in determining whether a first mobile communication device presented to the safe is allowed to access the inside of the safe.

5. The safe of claim 4, wherein the safe is configured to deny access to the inside of the safe unless the second access control device confirms that the first mobile communication device corresponds to a valid credential.

6. The safe of claim 1, further comprising a lock mechanism that is actuated based on decisions received from the access control module.

7. The safe of claim 1, wherein the safe is further configured to write an access control log back to the mobile communication device, wherein the access control log written back to the mobile communication device describes access control events associated with the safe.

8. A method, comprising:
determining that a user has presented a Near Field Communications (NFC)-enabled communication device to an in-room safe; and
determining whether the NFC-enabled communication device was presented to a different access control device associated with the room in which the in-room safe is located; and
conditioning admission to the in-room safe on the determination of whether the NFC-enabled communication device was presented to the different access control device.

9. The method of claim 8, wherein admission to the in-room safe is further conditioned upon the NFC-enabled communication device having permissions to access the in-room safe.

10. The method of claim 8, wherein the NFC-enabled communication device corresponds to a mobile communication device.

11. The method of claim 8, wherein the NFC-enabled communication device receives a token from the different access control device and presents the token to the in-room safe to prove that the NFC-enabled communication device has been presented to the different access control device.

12. The method of claim 8, wherein the different access control device communicates directly with the in-room safe to inform the in-room safe that the NFC-enabled communication device was presented thereto.

13. The method of claim 8, further comprising:
determining that the NFC-enabled communication device is allowed admission to the in-room safe; and
actuating a lock mechanism of the in-room safe.

14. The method of claim 13, further comprising:
writing access control log information from the in-room safe back to the NFC-enabled communication device to indicate that the NFC-enabled communication device was allowed admission to the in-room safe.

15. A non-transitory computer-readable medium comprising processor-executable instructions that, when executed by the processor, enable execution of the method of claim 8.

16. An Application-Specific Integrated Circuit (ASIC) configured to execute the method of claim 8.

17. Firmware configured to execute the method of claim 8.

18. A hotel room security system, comprising:
a first access control device positioned in proximity to a door separating a hotel room from a public area of the hotel; and
a second access control device positioned within the hotel room and configured to restrict access to an asset contained within the hotel room, wherein the second access control device is configured to condition access to the asset based on whether or not an access credential was presented to and validated by the first access control device prior to being presented to the second access control device.

19. The system of claim 18, wherein the access credential and the second access control device exchange communications using Near Field Communications (NFC).

20. The system of claim 18, wherein the asset comprises an in-room safe.
